(19) United States
(12) Patent Application Publication
(10) Pub. No.: US 2018/0068084 A1
(43) Pub. Date: Mar. 8, 2018

(54) SYSTEMS AND METHODS FOR CARE PROGRAM SELECTION UTILIZING MACHINE LEARNING TECHNIQUES

(71) Applicant: eClinicalWorks, LLC, Westborough, MA (US)

(72) Inventors: Girish Navani, Westborough, MA (US); Neha Singh, Framingham, MA (US); Arvind Sampath, Grafton, MA (US)

(21) Appl. No.: 15/696,828

(22) Filed: Sep. 6, 2017

Related U.S. Application Data
(60) Provisional application No. 62/384,491, filed on Sep. 7, 2016.

(51) Int. Cl. G06F 19/00; G06N 99/00

(52) U.S. Cl. CPC G06F 19/3431; G06N 99/005; G06F 19/3406; G06F 19/3418; G06F 19/322

(57) ABSTRACT

Systems, methods, apparatuses and computer program products are provided for monitoring and managing patient health conditions. Information is stored for defining care channels corresponding to health categories which are utilized to classify patients based on health status and risk information. Patient information is retrieved from a plurality of data sources, and analyzed to detect care node flags that identify unfavorable health conditions and to assign a care channel to the patient. One or more care programs are assigned to the patient based, at least in part, on the assigned care channel and detected care node flags. The patient is transitioned to one or more care channels as the patient's health improves or degrades. A personalized health timeline is generated for the patient which summarizes the patient's medical history and other related information.

### CROSS-REFERENCE TO RELATED APPLICATIONS

The present application claims the benefit of U.S. Provisional Application No. 62/384,491 filed on Sep. 7, 2016, the content of which is herein incorporated by reference in its entirety.

### FIELD OF THE INVENTION

The present disclosure is directed to a medical platform that provides assistance with patient care treatment and, more particularly, to a medical platform that is configured to classify patients based on health and risk status information and to dynamically generate health timelines for monitoring the progression of health statuses of the patients.

### BACKGROUND

Traditional approaches for treating patients focus on the present symptoms of the patients. These approaches are “episodic” in the sense that they tend to focus on the immediate or current conditions of patients, without considering other factors such as the patient's overall medical history. Consequently, the majority of medical services provided are directed to treating high risk patients or patients who are already diagnosed with a condition, with little attention paid to preventive care for healthy patients or patients who are at risk of developing certain conditions.

Medical practitioners (e.g., doctors or other health care professionals) may assign treatment or care programs (e.g., which may specify actions, medication or the like in connection with treating and/or preventing medical conditions) to address or treat the patients' conditions. However, there is no easy way to evaluate and compare the effectiveness of such programs based on prior results of other patients who have previously adhered to the care programs. Consequently, the medical practitioners may continuously reassign ineffective care programs to the patients.

In view of the foregoing, there is a need for a medical platform that can recommend care programs for treating patients in a manner that considers the entirety of the patients' medical history and other behaviors. There is a further need to automatically evaluate the effectiveness of such care programs and to adjust care program recommendations based on their effectiveness.

### SUMMARY

This disclosure relates to systems, methods, apparatuses and computerized software applications which utilize novel techniques for managing and treating patients. Automated functions classify patients based on health and risk status information. The medical information for the patients is segregated into a variety of care nodes that are utilized to determine the health statuses of patient. The care nodes group the patient information in various categories (e.g., diseases, chronic conditions, demographics, laboratory results, etc.). The patients are assigned to care channels based on the care node information which indicates their current health statuses. Care programs are assigned to the patients based on their assigned care channels and/or detected risk factors. As patient information is continuously received, the patients are transitioned to various care channels depending upon whether their heath improves or degrades. Health timelines are generated for the patients which indicate the progression of the patients throughout the care channels. The health timelines provide a unique perspective of the patients' medical histories and are configured to be interactive to provide detailed information pertaining to various events identified in the timelines.

In accordance with certain embodiments, a system is disclosed for monitoring and managing health conditions. The system comprises: a database that stores information for defining care channels and care nodes corresponding to health categories which classify patients based on health status and risk information, wherein the care channels are utilized to generate a personalized health timeline for each of the patients by tracking their progression through the care channels; and a computing device having a processor and a physical storage device that stores instructions. Execution of the instructions causes the computing device to: retrieve patient information corresponding to a patient from a plurality of data sources; analyze the patient information to detect care node flags that identify unfavorable health conditions; assign a care channel to the patient based, at least in part, on the detected care node flags; assign one or more care programs to the patient based, at least in part, on the assigned care channel and detected care node flags; transition the patient to one or more additional care channels as the patient's health improves or degrades; and generate a personalized health timeline for the patient based, at least in part, on the patient's progression through the care channels.

In accordance with certain embodiments, a method is disclosed for monitoring and managing health conditions. The method includes: storing, on a non-transitory computer storage medium, information for defining care channels corresponding to health categories which classify patients based on health status and risk information, wherein the care channels are utilized to generate a personalized health timeline for each of the patients by tracking their progression through the care channels; retrieving patient information corresponding to a patient from a plurality of data sources; analyzing the patient information to detect care node flags that identify unfavorable health conditions; assigning a care channel to the patient based, at least in part, on the detected care node flags; assigning one or more care programs to the patient based, at least in part, on the assigned care channel and detected care node flags; transitioning the patient to one or more additional care channels as the patient's health improves or degrades; and generating a personalized health timeline for the patient based, at least in part, on the patient's progression through the care channels.

The foregoing and other features and advantages will become apparent from the following detailed description of illustrative embodiments thereof, which is to be read in connection with the accompanying drawings.

### BRIEF DESCRIPTION OF THE DRAWINGS

The inventive principles are illustrated in the figures of the accompanying drawings which are meant to be exemplary and not limiting, in which like references are intended to refer to like or corresponding parts, and in which:

FIG. 1 is a block diagram of a system according to certain embodiments;

FIG. 2 is a flow chart which illustrates a process flow demonstrating how the medical platform assigns care channels and care programs to patients according to certain embodiments;

FIG. 3 is a diagram which demonstrates how patient information is loaded into care nodes and sub-nodes in accordance with certain embodiments;

FIG. 4 is an illustration of an exemplary decision tree for assigning care channels to patients in accordance with certain embodiments;

FIG. 5 is a flow chart showing an exemplary process flow for assigning care programs in accordance with certain embodiments; and

FIG. 6 is a flow chart illustrating an exemplary method for operating a medical platform in accordance with certain embodiments.

### DESCRIPTION OF EXEMPLARY EMBODIMENTS

In accordance with certain embodiments, a medical platform is configured to assist medical practitioners with treating patients by classifying patients into a plurality of clinical categories (referred to as “care channels”) based upon health status and risk information, and recommending patient care programs designed to improve or maintain health conditions of the patients. The patients are transitioned to various care channels as their health improves or degrades. Each patient is initially assigned to a care channel based on an initial or current state of their health status and risk information, and the patient is assigned one or more care programs which are designed to improve or maintain the patient's health. The health status and risk information of the patient is monitored, and the patient is transitioned to different care channels and assigned different care programs as the monitored health status and risk information indicates that the patient's health has improved or degraded. A health timeline is generated, and dynamically updated over time, by tracking the patient's progression through the different care channels and monitoring various aspects of the patient's health. The health timeline provides a unique way of viewing the evolution of the patient's health over a period of time and can be utilized to quickly identify certain driving conditions which have substantially impacted the patient's health over time.

The medical platform extracts or receives patient information utilized to assign the care channels to patients from a variety of different data sources (e.g., sources which provide medical records, laboratory results, demographic information and pharmaceutical information). The information for each patient includes granular data and information pertaining to various aspects of the patient's medical history and other relevant information (e.g., the results of particular lab tests, particular measurements of vitals from previous examinations, particular medications that were prescribed, social habits, etc.). The medical platform can process the patient information to normalize the data and to process the patient information to derive additional attributes or variables for the patients. The medical platform executes a function which processes the patient information and organizes the information into logical classifications (referred to as “care nodes”) which allow the patient's health characteristics to be understood and analyzed in a meaningful way. The care nodes capture the information which is used to determine the state of the patients' health.

Each care node can include a collection of patient information that is associated with the node, as well as program instructions and functions which process this information to provide a meaningful analysis to the patient information. Exemplary care nodes can include: a predictive risk score node (e.g., which includes patient information for computing one or more risk scores which indicate a probability or propensity that a patient will develop a medical condition), vitals node (e.g., which includes vital information and functions which analyze the information to determine risk conditions), and a laboratory results node (e.g., which includes results of laboratory tests and related information, and functions which analyze this information to identify risk conditions)). As explained below, other types of care nodes can be utilized to analyze the patient information in a meaningful way. Each care node can further include one or more sub-nodes which capture a subset of the information associated with its parent node, and which utilizes functions to process the subset of the information to compute meaningful variables. For example, the laboratory results node may include several sub-nodes (e.g., a sub-node relating to cholesterol lab reports, diabetes lab reports, etc.) and each sub-node may process the subset of relevant information to glean important information from the subset of information and to identify risk information in the subset of information.

The care nodes and associated patient information may then be utilized to classify each patient into one of the care channels based on the patient's health status and risk information. The medical platform stores a set of rules which analyze the node information to determine the patients' health status and risk information and to assign appropriate care channels to the patients. The rules include sets of decisions trees which utilize the patient information and variables associated with the care nodes to select the care channels. Exemplary care channels may represent health statuses such as “healthy,” “healthy-at-risk,” “condition pre-diagnostic,” etc. The rules utilize the decision trees to identify “care node flags” which indicate the presence of adverse or unfavorable health and risk conditions (e.g., abnormal vitals, abnormal laboratory results, and/or diseases or serious health conditions). Care channels are then assigned to the patients based on the detected care node flags and/or other information associated with the care nodes.

Each care channel is associated with one or more care programs. The care programs include health plans and recommendations directed at improving or maintaining the health of the patients. One or more appropriate care programs may then be selected and assigned to each of the patients. In certain embodiments, the selection and assignment of the care programs may be based, at least in part, on machine learning techniques which utilize prior patient results to evaluate the effectiveness of the care programs. Patients may be transitioned to different care channels and reassigned new care programs in the event the patients' health has improved or deteriorated. The health timeline generated for a patient show a patient's progression through the various care channels (and associated information, e.g., such as care programs that were assigned, medications prescribed, patient compliance or adherence information, etc.). The care channels and/or care programs may further analyze the health timeline for the patient to identify driving conditions which have had a substantial impact on the patient's health (e.g., to identify driving conditions which caused one or more additional complications or comorbidities for the patient).

The inventive principles set forth in the disclosure provide a variety of advantages over conventional techniques for treating patients. In contrast to prior art techniques which treat patients “episodically” by focusing on the immediate or current conditions of patients, the inventive principles discussed herein provide unique techniques for assessing and treating patients by generating a patient health timeline which encompasses the overall medical history for the patients and which tracks the patients' progression over time. This inventive approach permits medical practitioners to both effectively treat medical conditions that immediate require attention, and to prevent healthy patients from developing medical conditions. Moreover, the medical platform can further allow medical practitioners to evaluate and compare the effectiveness of care programs based on prior results of other patients who have previously adhered to the care programs. Medical practitioners can avoid reassigning care programs which are identified by the platform as ineffective, and can easily identify and prioritize care programs that have high success rates.

The inventive principles set forth in the disclosure are rooted in computer technologies which overcome existing problems in patient treatment, specifically problems dealing with monitoring patient health and risk information over extended periods of time, and recommending optimal patient care programs in automated fashion. As explained above, current treatment techniques address patients' health issues in an episodic manner and fail to provide adequate preventive care options. These techniques also fail to utilize feedback from previous patients to adequately adjust recommendations for patient treatment. The inventive principles described in this disclosure provide a technical solution (e.g., which utilizes machine learning techniques to optimize care program selections and which utilizes an entire universe of patient information to make such selections) for overcoming such problems. The techniques utilize a novel set of rules which include decision trees for assigning patients to care channels and care programs, and which dynamically transition the patients to different care channels and programs based on the progression of their health over time. This technology-based solution marks an improvement over existing patient treatment tools by improving the selection of care programs in an automated fashion that can learn from previous patient feedback.

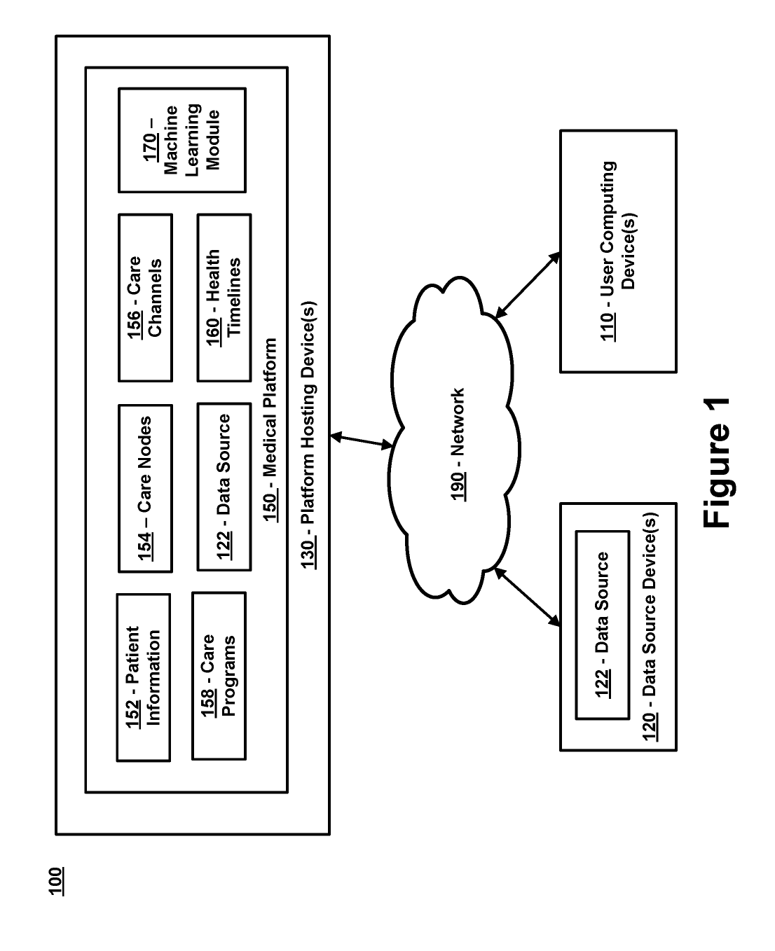

Referring now to the drawings in which like numerals represent the same or similar elements and initially to FIG. 1 which illustrates an exemplary system 100 for managing and maintaining health information in accordance with certain embodiments. The system 100 includes a user computing device 110, a content data source device 120, and a platform hosting device 130. The user computing device 110, content distribution device 120 and platform hosting device 130 are in communication with each other over a network 190. The network 190 may be any type of network such as one that includes the Internet, a local area network, a wide area network, an intranet, a cellular network, and/or other networks. For ease of reference, FIG. 1 only shows a single computing device 110, a single data source device 120, and a single platform hosting device 130. However, it should be recognized that any number of user computing devices 110, content distribution devices 120, and platform hosting devices 130 may be incorporated into the system 100 and connected to the network 190, and each of the devices may be configured to communicate with one another via the network 190.

Generally speaking, the platform hosting device 130 is configured to store, provide, and/or host a medical platform 150 that utilizes improved techniques for monitoring a patient's health as it improves or degrades, and for providing appropriate medical plans and recommendations to the patients as they transition through different care channels 156. Tracking the patients' progression through the care channels 156 enables the medical platform 150 to generate, and continuously update, health timelines 160 for the patients. As explained herein, the health timelines 160 provide medical practitioners and patients with a unique and comprehensive viewpoint of the patients' entire medical histories.

The user computing devices 110 allow a user to access the medical platform 150 over the network 190 (e.g., to permit the user to access or update patient information 152 or health timelines 160). In certain embodiments, the medical platform 150 may be implemented as a local application that is installed on computing devices operated by the users of the platform (e.g., installed directly on user computing devices 110). In such embodiments, the user computing device 110 may represent a platform hosting device 130, or vice versa. In certain embodiments, the search platform 150 may alternatively, or additionally, represent a network-based, web-based and/or cloud-based platform that is accessed over a network 190 by the users using the user computing devices 110. For example, the platform hosting device 130 may represent one or more servers, or other devices, that are configured to communicate with the user computing devices 110 operated by the users (e.g., to provide access to the medical platform 150). Exemplary users may include medical practitioners (e.g., doctors, nurses, physical therapists, physician assistants, and/or any other individuals associated with providing health care services) who utilize the platform in connection with providing medical services to patients and/or patients (e.g., who can logon to the platform to view their medical information or medical information for family members).

The user computing devices 110, data source devices 120, and platform hosting devices 130 may represent desktop computers, laptop computers, mobile devices (e.g., cell phones, smart phones or personal digital assistants), tablet devices, server devices (e.g., mainframe server devices and/or devices with web servers), or other types of computing devices. The user computing devices 110, data source devices 120, and platform hosting devices 130 may be configured to communicate via wired or wireless links, or a combination of the two. Each may be equipped with one or more computer storage devices (e.g., RAM, ROM, PROM, SRAM, etc.) and one or more processing devices (e.g., central processing units) that are capable of executing computer program instructions. The computer storage devices are preferably physical, non-transitory mediums.

The medical platform 150 may initially receive and process patient information 152 associated with a variety of different data sources 122 (e.g., databases associated with medical providers, laboratories, pharmacies, etc.). The data sources 122 may be stored on the platform hosting device 130 which provides the medical platform 150. Additionally, or alternatively, the data sources 122 may be stored on one or more separate data source devices 120. For example, the data source devices 120 may represent devices owned and operated by third parties and may include data sources 122 which store various types of patient information 152 (e.g., lab result information, medical record information, etc.). The medical platform 150 may communicate with the data source devices 120 over the network 190 to obtain or retrieve the patient information 152.

The patient information 152 may generally include any information associated with patients. Exemplary types of patient information include, inter alia, medical history records, electronic health records (EHRs), laboratory reports, pharmacy data (e.g., indicating prescriptions and the patients' adherence to filling the prescriptions), family history data, demographic information (e.g., indicating a patient's age, race, ethnicity, nationality, etc.), social history data (e.g., indicating familial, occupational and recreational aspects of a patient's life including, but not limited to, habits relating to exercise tendencies, drug and alcohol consumption, traveling, sexual preferences and diet), surgical history data, chronic condition and disease information, a patient's appointment behavior (e.g., indicating how often a patient seeks medical attention or attends scheduled appointments), medication history information and any other data associated with the patients. The platform 150 may be configured to process such data to correct errors in the data, to normalize the data into a format for use by the platform 150, and to derive certain variables or characteristics associated with the patients. In contrast to current treatment methods which address patient health issues in an episodic manner, the medical platform 150 provides a more comprehensive approach to addressing patient health issues by utilizing any or all of the above data to treat patients.

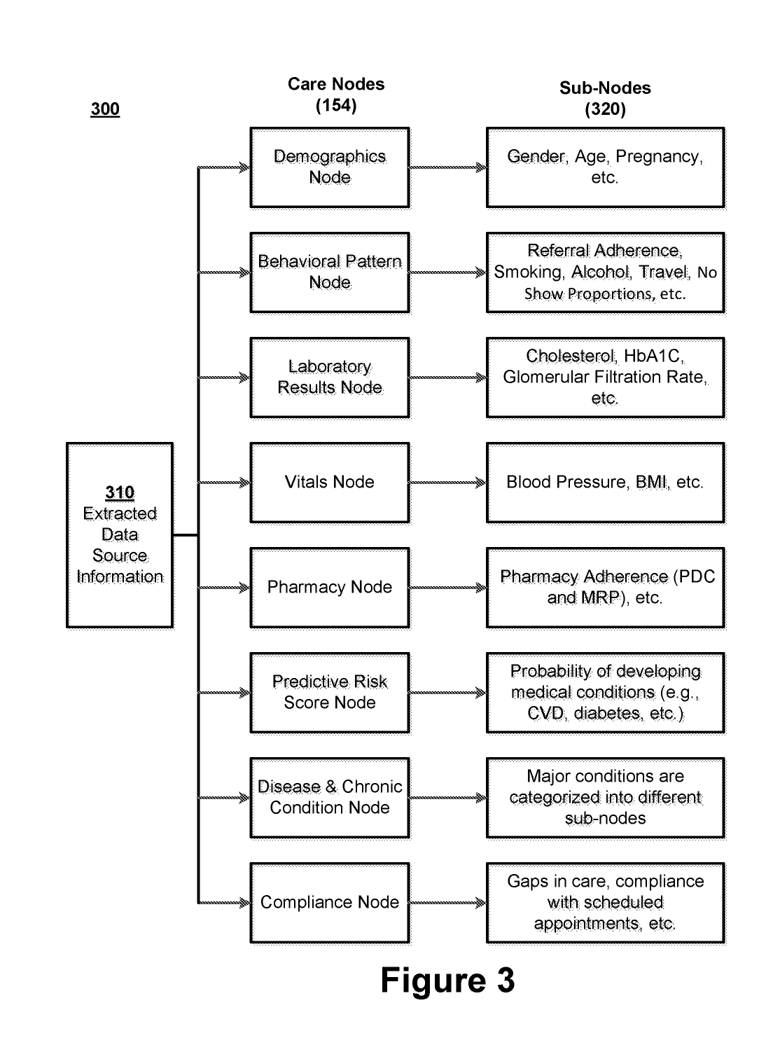

After the patient information 152 is retrieved by the medical platform 152, the medical platform 150 executes a function which analyzes the patient information 152 and categorizes the patient information 152 into a plurality of logical classifications that are utilized to determine the health of the patient. These logical classifications are stored on the platform 150 as care nodes 154. Each of the care nodes 154 is directed to an information category that can be utilized to determine the health of the patient. Exemplary care nodes may include any or all of the following categories: chronic conditions and diseases, laboratory results, pharmaceutical information, patient behavioral patterns, demographic information, vitals information, predictive risk scores, and patient compliance. Other types of nodes may also be utilized by, and stored on, the platform 150. Exemplary sub-nodes are illustrated in FIG. 3.

Each care node 154 may include one or more sub-nodes. Each sub-node may correspond to a subset of information that is included in the care node 154. For example, in the case that a care node 154 is provided which relates to chronic conditions and diseases, the care node 154 may include a plurality of sub-nodes corresponding to various chronic conditions and diseases. Any patient information corresponding to the chronic conditions and disease can be imported into the sub-nodes.

The care nodes 154 may also include and/or be associated with instructions for detecting “care node flags.” Generally speaking, care node flags identify the presence of adverse or unfavorable health conditions. For example, the care node flags may indicate whether a patient has low pharmacy adherence, low referral adherence, abnormal vitals, abnormal laboratory results, diseases or serious health conditions (e.g., diabetes, hypertension or cardiovascular disease) and/or chronic conditions. The medical platform 150 is configured to analyze the patient information 152 imported into the care nodes 154 (and any sub-nodes) to detect the presence of care node flags, thereby identifying adverse or unfavorable health conditions in each of the categories or classifications represented by the care nodes 154.

In addition to storing the patient information 152 and care nodes 154, the medical platform 150 may further store information associated with care channels 156 and care programs 158. The care channels 156 may generally represent health categories which are utilized to classify patients based on their health status and risk information. The care node flags identified by the medical platform 150, at least in part, are utilized to assign patients to the care channels 156. In certain embodiments, the stored information relating to the care channels 156 may include the following categories:

(1) Healthy: Patient subset which does not have any known lifestyle complications. Patients have normal laboratory results and vital values. Patients who have had visits to health care providers for minor conditions which do not substantially increase risk factors for serious conditions may still be characterized as healthy. In certain embodiments, patients will be assigned to this care channel 156 if their patient information 152 satisfies the following criteria:

Vitals
Blood Pressure [90<=Sys<=120, 60<=Dias<=80]
BMI [18.5-25]
Heart Rate [60-100]

Labs
Lipids [Tot Chol<200, TriGly<150, LDL<130, HDL>50]
Blood Glucose [70-100 mg/dl]
Blood Urea Nitrogen [Adults: 7-20 mg/dl, Children: 5-18 mg/dl]
Serum Creatinine [Female: 0.6-1.2 mg/dl , Male 0.5-1.5 mg/dl]
Hemoglobin [12-15 g/dl]

Risk Calculators
Hypertension<50%
Diabetes<50%
Cardiovascular Disease<50%

Chronic Conditions—Zero

Inpatient Visits/Emergency Visits—<=2 for Acute Conditions

(2) Healthy At-Risk: Patient subset which is at the moderate to high risk of developing one or more serious health conditions. For example, the patients in this category may consistently have laboratory results and vital values in abnormal ranges and, thus, the probability of having a serious health condition would be higher. In certain embodiments, patients will be assigned to this care channel 156 if their patient information 152 satisfies the following criteria:

### Vitals

Blood Pressure [120<=Sys<=139, 80<=Dias <=89]/OR

BMI [25-29.9]/OR

Heart Rate [60-100]/OR

### Labs

Lipids [Tot Chol (Cholesterol): 200-240, TriGly: 150-500, LDL: 130-160, HDL: 35-50]

Blood Glucose [100-125 mg/dl]

Blood Urea Nitrogen [Adults: 7-20 mg/dl, Children: 5-18 mg/dl]

Serum Creatinine [Female: >1.2 mg/dl , Male>1.4 mg/dl]

Hemoglobin [11-12 g/dl]

### Risk Calculators

Hypertension [50-80%]

Diabetes [50-80%]

Cardiovascular Disease [50-80%]

### Chronic Conditions—Zero

### Inpatient Visits/Emergency Visits—<=2 for Acute Conditions

(3) Condition Pre-Diagnostic (CPD): Patient subset which has a very high risk of developing a serious health condition. For example, this may include patients having hypertension, high cholesterol and/or unfavorable laboratory results and vital values. In certain embodiments, patients will be assigned to this care channel 156 if their patient information 152 satisfies the following criteria:

### Vitals

Blood Pressure [120<=Sys<=139, 80<=Dias<=89]/OR

BMI [25-29.9]/OR

Heart Rate [60-100]/OR

### Labs

Lipids [Tot Chol: 200-240, TriGly: 150-500, LDL: 130-160, HDL: 35-50]

Blood Glucose [100-125 mg/dl]

Blood Urea Nitrogen [Adults: 7-20 mg/dl, Children: 5-18 mg/dl]

Serum Creatinine [Female: >1.2 mg/dl , Male>1.4 mg/dl]

Hemoglobin [11-12 g/dl]

### Risk Calculators

Hypertension [>80%] or Diagnosed with Hypertension

Diabetes [>80%]

Cardiovascular Disease [>80%]

### Chronic Conditions—Zero

### Inpatient Visits/Emergency Visits<=3 for Acute Conditions

(4) Driving Condition Encounter (DCE): Patient subset which was recently diagnosed with a serious health condition, or which has been with at least one health condition diagnosed in the past, but which has stable laboratory results and vital values. The health condition may be a driving condition in the patients' health timeline. In certain embodiments, patients will be assigned to this care channel 156 if their patient information 152 satisfies the following criteria:

### Vitals

Blood Pressure [120<=Sys<=139, 80<=Dias<=89]/OR

BMI [25-29.9]/OR

Heart Rate [60-100]/OR

### Labs

Lipids [Tot Chol: 200-240, TriGly: 150-500, LDL: 130-160, HDL: 35-50]

Blood Glucose [100-125 mg/dl]

Blood Urea Nitrogen [Adults: 7-20 mg/dl, Children: 5-18 mg/dl]

Serum Creatinine[Female: >1.2 mg/dl , Male>1.4 mg/dl]

Hemoglobin [11-12 g/dl]

### Risk Calculators

Hypertension [80 -90%]

Diabetes [80-90%]

Cardiovascular Disease [80-90%]

### Chronic Conditions—One

### Inpatient Visits/Emergency Visits—<=2 for Acute Conditions

(5) Condition Progression Level 1 (CPL 1)—Beginning of Progression:

Patient subset which has been diagnosed with at least one chronic or health condition and which has started showing signs of complications. In certain embodiments, patients will be assigned to this care channel 156 if their patient information 152 satisfies the following criteria:

### Vitals

Blood Pressure [140 <=Sys, 90<=Dias]/OR

BMI [25-29.9]/OR [>30]

Heart Rate [60-100]/OR

### Labs

Lipids [Tot Chol: >240, TriGly: >500, LDL: >160, HDL: <35] OR

Blood Glucose [>200 mg/dl]—two readings some time apart

Blood Urea Nitrogen [Adults: 40-60 mg/dl, Children: 5-18 mg/dl]

Serum Creatinine [Female: >1.2 mg/dl , Male>1.4 mg/dl]

GFR [>90]

### Risk

Diabetes [90%]

Cardiovascular Disease [90%]

CHF/CHD [50-80%]

Chronic Conditions—One plus showing signs of other complications

### Inpatient Visits/Emergency Visits—<=2 for Acute Conditions

(6) Condition Progression Level 2 (CPL 2)—Comorbidities/MCCs (Major Complications/Comorbid Conditions): Patient subset started developing other health conditions (comorbidities) in addition to a first driving condition. In certain embodiments, patients will be assigned to this care channel 156 if their patient information 152 satisfies the following criteria:

### Vitals

Blood Pressure [140<=Sys, 90<=Dias]/OR

BMI [25-29.9]/OR [>30]

Heart Rate [60-100]/OR

### Labs

Lipids [Tot Chol: >240, TriGly: >500, LDL: >160, HDL: <35] OR

Blood Glucose [>200 mg/dl]—two readings some time apart

Blood Urea Nitrogen [Adults: 40-60 mg/dl, Children: 5-18 mg/dl]

Serum Creatinine [Female: >1.2 mg/dl, Male>1.4 mg/dl]

GFR [>90]

### Risk

Diabetes [90%]

Cardiovascular Disease [90%]

CHF/CHD/CKD [90%]

Chronic Conditions—One+One or more Comorbidity (e.g., cardiovascular disease (CVD), congestive heart failure (CHF), and/or chronic kidney disease (CKD))
Inpatient Visits/Emergency Visits<=5 for Acute Conditions and chronic conditions

(7) Condition Progression Level 3 (CPL 3): Patient subset in later or advanced stages of a driving condition or comorbidity, or both. In certain embodiments, patients will be assigned to this care channel 156 if their patient information 152 satisfies the following criteria:

### Vitals

Blood Pressure [140<=Sys, 90<=Dias]/OR

BMI [25-29.9]/OR [>30]

Heart Rate [60-100]/OR

### Labs

Lipids [Tot Chol: >240, TriGly: >500, LDL: >160, HDL: <35] OR

Blood Glucose [>200 mg/dl]—two readings some time apart

Blood Urea Nitrogen [Adults: 40-60 mg/dl, Children: 5-18 mg/dl]

Serum Creatinine[Female: >1.2 mg/dl , Male>1.4 mg/dl]

GFR [>90]

### Risk

Diabetes [90%]

Cardiovascular Disease [90%]

CHF/CHD/CKD [90%]

Chronic Conditions—One+One or more Comorbidity (e.g., CVD, CHF, and/or CKD)
Inpatient Visits/Emergency Visits<=5 for Acute Conditions and chronic conditions

(8) Condition Progression Level 4 (CPL 4)—Patient subset in final or critical stages of any one or more health conditions. In certain embodiments, patients will be assigned to this care channel 156 if their patient information 152 satisfies the following criteria:

### Vitals

Blood Pressure [140<=Sys, 90<=Dias]/OR

BMI [25-29.9]/OR [>30]

Heart Rate [60-100]OR

### Labs

Lipids [Tot Chol: >240, TriGly: >500, LDL: >160, HDL: <35] OR

Blood Glucose [>200 mg/dl]—two readings some time apart

Blood Urea Nitrogen [Adults: 40-60 mg/dl, Children: 5-18 mg/dl]

Serum Creatinine [Female: >1.2 mg/dl , Male>1.4 mg/dl]

GFR [>90]

### Risk

Afib/Stroke/Intermittent Claudication [90%]

CHF/CHD/CKD [90%]

Chronic Conditions—More than two chronic conditions
Inpatient Visits/Emergency Visits<=5 for Acute Conditions and chronic conditions

(9) Surgical Procedure—Patient subset who has experienced or will be experiencing surgery. This may include surgeries directed to treating a health condition or major surgeries unrelated to treating a health condition. In certain embodiments, patients will be assigned to this care channel 156 if their patient information 152 satisfies the following criteria:

### Vitals

Blood Pressure [140<=Sys, 90<=Dias]/OR

BMI [25-29.9]/OR [>30]

Heart Rate [60-100]/OR

### Labs

Lipids [Tot Chol: >240, TriGly: >500, LDL: >160, HDL: <35] OR

Blood Glucose [>200 mg/dl]—two readings some time apart

Blood Urea Nitrogen [Adults: 40-60 mg/dl, Children: 5-18 mg/dl]

Serum Creatinine [Female: >1.2 mg/dl , Male>1.4 mg/dl]

GFR [>90]

### Risk

Cardiovascular Disease [90%]

CHF/CHD/CKD [90%]

Chronic Conditions—One+One or more Comorbidity (e.g., CVD, CHF and/or CKD,)
Surgery->1 (Treatment or Non-Treatment Procedures) [within 6 months]
Inpatient Visits/Emergency Visits<=7 for Acute Conditions and chronic conditions

(10) Recovery—Patient subset in recovery and stabilizing after surgery. In certain embodiments, patients will be assigned to this care channel 156 if their patient information 152 satisfies the following criteria:

### Vitals

Blood Pressure [140<=Sys, 90<=Dias]/OR

BMI [25-29.9]/OR [>30]

Heart Rate [60-100]/OR

### Labs

Lipids [Tot Chol: >240, TriGly: >500, LDL: >160, HDL: <35] OR

Blood Glucose [>200 mg/dl]—two readings some time apart

Blood Urea Nitrogen [Adults: 40-60 mg/dl, Children: 5-18 mg/dl]

Serum Creatinine [Female: >1.2 mg/dl , Male>1.4 mg/dl]

GFR [>90]

### Risk

Afib/Stroke/Intermittent Claudication [90%]

CHF/CHD/CKD [90%]

Chronic Conditions—More than two chronic conditions
Surgery—>1 (Treatment or Non-Treatment Procedures) [after 6 months]
Inpatient Visits/Emergency Visits<=5 for Acute Conditions and chronic conditions

The medical platform 150 may characterize patients into one or more of the above care channels 156 based on the patient information 152 and the care node flags detected in the patient information 152. Designations provided by medical practitioners (e.g., via an interface provided by the platform 150 on a user device 110) can also be used to explicitly assign care channels 156 to patients. In certain embodiments, each patient is assigned to a single care channel 156 at any given time. In other embodiments, the care channels 156 may be defined in a manner that patients may be assigned to two or more care channels 156 at any given time.

In certain embodiments, the medical platform 150 is configured to dynamically update the patient information 152 for the patients and to adjust the care channels 156 assigned to the patients based on the updated patient information 152. Updates to the patient information 152 may be provided in a variety of ways. In certain embodiments, the medical platform 150 is configured to periodically access the data sources 122 comprising the patient information 152 to determine if new information is available and to retrieve updates if available. Additionally, or alternatively, the medical platform 152 may be linked to the data sources and each time new information is entered for the patients, the patient information 152 is automatically transmitted to or accessed by the platform 150. Updates may be provided in other ways as well. Regardless of how the updates are provided, the updated information is processed by the medical platform 150 in the same manner as described above (e.g., by normalizing the information, importing the information into care nodes 154, and identifying care node flags) to assess the health of the patients and to assign an appropriate care channel 156 to the patients.

Each of the above care channels 156 may be associated with a plurality of care programs 158 that can be utilized to treat patients. The care programs 158 are designed to improve the health status of the patients and/or to maintain the health status of already healthy patients. For example, each of the care programs 158 may include recommendations pertaining to implementing dietary habits, prescribing medications, conducting laboratory testing, scheduling medical practitioner appointments, and/or any other actions or recommendations for improving or maintaining the health statuses of patients.

The assignment of the care programs 158 is based, at least in part, on the care channel 156 assigned to the patient and the care node flags detected in the patient information 152 associated with the patient's care nodes 154. For example, to select an appropriate care program(s) 158 for a patient, the platform 150 may compare the patient information to certain variables (e.g., such as the care node flags) for identifying the presence of adverse or unfavorable health conditions. Each care channel 156 may be associated with a particular set of care programs 158.

In certain embodiments, the selection or recommendation of the care programs 158 is made utilizing automated, machine learning techniques which executed by a machine learning module 170. To accomplish this, the machine learning module 170 may store a plurality of care programs 158 for each health condition and evaluate which of the care programs 158 most effectively treats the health condition. For example, if the platform is recommending a care program for treating a patient with hypertension, the platform may store a plurality of different care programs 158 that can be utilized to treat hypertension. Each of the care programs 158 may be assigned a priority ranking by the machine learning module 170 which indicates a preference for selecting each of the care programs 158. The care program 158 having the highest priority ranking may be recommended or selected for treating patients. The patients' adherence to the care programs 158 and the effectiveness of the care programs 158 may be monitored and the associated details may be input or supplied to the machine learning module 170. The machine learning module 170 may utilize this feedback to adjust the priority rankings assigned to each of the care programs 158. For example, care programs 158 that are effective may be given greater or increased priority rankings so that the care program 158 is more likely to be recommended to patients, while programs 158 that are not effective or less effective may be given lower or decreased priority rankings so that such programs 158 are less likely to be recommended to patients. In this manner, the machine learning module 170 can dynamically adjust the selection of care programs 158 in an intelligent manner that results in the selection of care programs 158 that have been proven to be effective.

The medical platform 150 generates health timelines 160 for each of the patients. The health timelines 160 show a patient's progression throughout the care channels 156. For example, in the case that a patient's health has degraded over time, the health timeline 160 for the patient may show that patient transition from care channels associated with healthier statuses (e.g., Healthy or Health-at-Risk) to care channels associated with less healthy statuses (e.g., Condition Progression Level 2 or Condition Progression Level 3). In this example, the health timeline 160 can be analyzed to quickly identify the driving condition which caused the degradation in the patient's health.

The health timelines 160 generated by the medical platform 150 can include a wide variety of information associated with patients' medical histories and can be displayed in a variety of ways. In certain embodiments, the health timelines 160 may be displayed in graphical form (e.g., using an illustration of a chronological timeline) on a graphical user interface presented on a user computing device 110. Each event in a patient's medical history and/or each piece of medical information may be associated with a date and/or time (e.g., using timestamp information). For example, laboratory results and medical examination can be associated with date and/or time information indicating when tests and examinations were conducted. Likewise, pharmacy data may indicate when medications are prescribed and/or filled. The medical platform 150 may include a function that utilizes this time and date information to generate a graphical depiction of the patient's medical history. In certain embodiments, the medical platform utilizes the date and time information to dynamically generate an illustration of a timeline which provides a visual depiction of a patient's medical history (e.g., indicating dates of diagnoses, treatments, surgeries, development of comorbidities, etc.).

The health timelines 160 can include interactive features which enable users to obtain a variety of information and to perform various functions. For example, interactive features may permit the users to select events on the health timelines 160 to obtain more information pertaining to the events (e.g., to view medical records, lab tests, medical practitioner notes taken during an examination, etc.). Other interactive features permit the users to send the health timelines 160 to other individuals (e.g., to other medical practitioners for analysis or for supplementary medical opinions), to download a copy of the health timelines 160, and/or to print a hardcopy of the health timelines 160.

The health timelines 160 can be useful tools for identifying driving conditions which have resulted in, or which may potentially result in, complications and/or comorbidities. The visual depictions of the health timelines 160 can allow a medical practitioner or other individual to quickly identify the driving conditions. In certain embodiments, the medical platform 150 can include automated functions which identify the driving conditions. For example, the automated function may analyze the timeline information to identify an initial health condition which occurred first in time and which caused subsequently occurring health conditions.

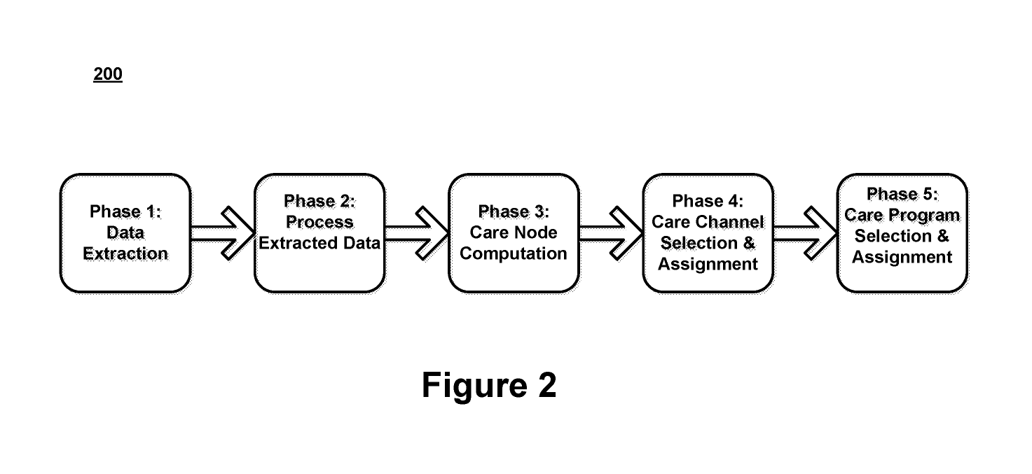

FIG. 2 is a flow chart which illustrates a process flow 200 demonstrating how the medical platform 150 assigns care channels and care programs to patients in accordance with certain embodiments.

In Phase 1, data comprising patient information 152 is extracted by the medical platform 150 from one or more data sources 122. As explained above, the data sources 122 may represent databases or data collections comprising patient information 152 which are stored locally on the platform hosting device 130 and/or databases or data collections comprising patient information 152 which are stored remotely on data source devices 120 which are accessible over the network 190.

In Phase 2, the extracted patient information is processed. One purpose of processing the patient information 152 is to normalize the data to be utilized by the medical platform 150. Another purpose of processing the extracted patient information 152 is to derive additional attributes or variables from the extracted patient information 152. The care nodes 154 may store variables that can be populated by using values in the patient information 152 to determine or infer other related values. For example, in the case that a patient's medical records indicate the patient has been prescribed allergy medication for several years, it may be inferred that the patient has allergies. The extracted patient information may be processed for other purposes as well.

In Phase 3, the care nodes 154 are computed for the patients using the extracted and processed patient information 152. Each care node 154 may be associated with a set of variables. The platform 150 analyzes the processed patient information 152 and assigns values to the variables based on the analysis of patient information 152. For example, if the patient's medical records indicate the patient had leukemia, a care node 154 corresponding to diseases may be populated with relevant information pertaining to the patient's condition.

FIG. 3 is a diagram 300 which demonstrates how patient information is loaded into care nodes 154 and sub-nodes 320 in accordance with certain embodiments. As shown, the extracted patient information 310 is imported into a plurality of care nodes 154. Each care node 154 includes a plurality of sub-nodes 320. For example, the demographics node 154 includes sub-nodes which summarize data related to age, pregnancies, gender, etc. Likewise, the laboratory results node 154 includes sub-nodes associated with test results for cholesterol, HbA1C, glomerular filtration rate, etc. Similarly, the vitals node 154 includes sub-nodes associated with blood pressure, body mass index (BMI), etc. Each of the nodes and/or sub-nodes may include values indicating the present health status of the patient, and historical values for indicating prior health statuses of the patient

Referring back to FIG. 2, in Phase 4, care channels 156 are selected and assigned to the patients. As explained above, the assignment of the care channels 156 may be based, at least in part, on the care node flags detected by the medical platform 150. The care channels 156 assigned to the patient indicate the current health status of the patients.

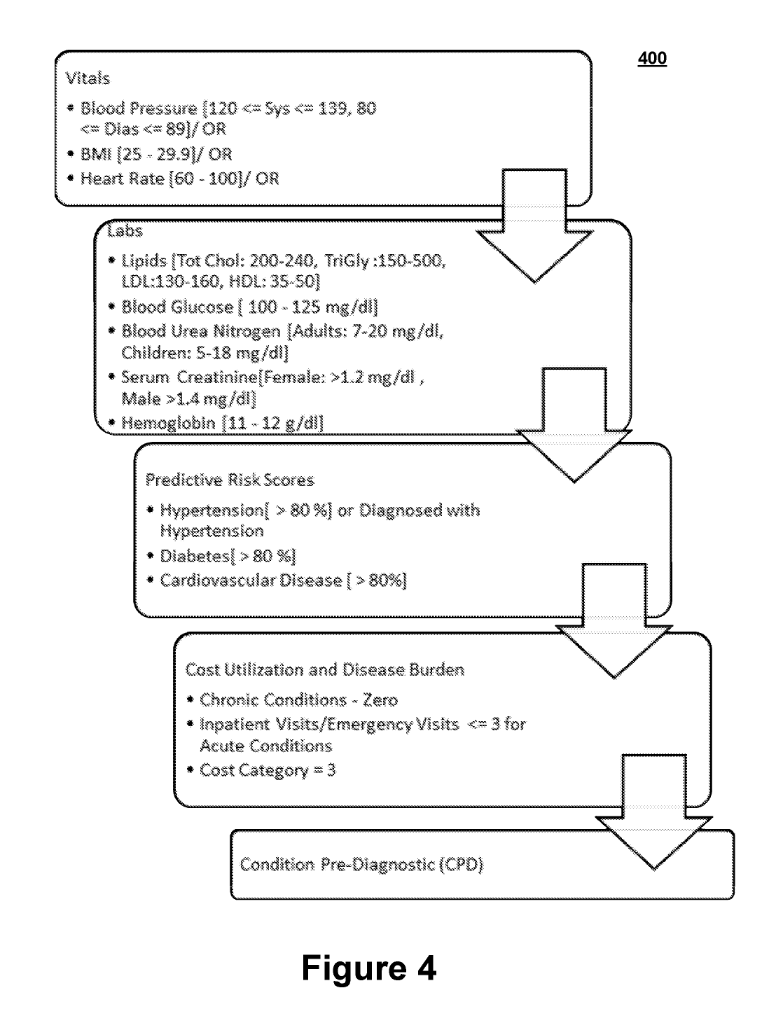

FIG. 4 is an illustration of an exemplary decision tree 400 that is utilized to assign care channels 156 to patients in accordance with certain embodiments. In this example, the decision tree 400 shows how a patient may be assigned to a condition pre-diagnostic (CPD) care channel 156. As shown, patients may be assigned to this care channel 156 if their vital values, lab results and/or predictive risk scores fall within particular ranges, while there have been no chronic conditions detected and the patient has had less than or equal to three acute conditions within a predetermined period of time. It should be apparent that the decision trees utilized to assign any of the care channels 156 can be customized in any appropriate manner to fit the classification scheme employed by the medical platform 150.

Referring back to FIG. 2, in Phase 5, care programs 158 are selected and assigned to the patients. As explained above, the assignment of the care programs 158 may be based, at least in part, on the care node flags detected by the medical platform 150 and/or the care channels 156 assigned to the patient. In certain embodiments, the care programs are selected using machine learning techniques that assess the effectiveness of care programs 158 previously assigned to other patients. The care programs are designed to improve the health statuses of the patients, and to transition the patients to healthier care channels 156.

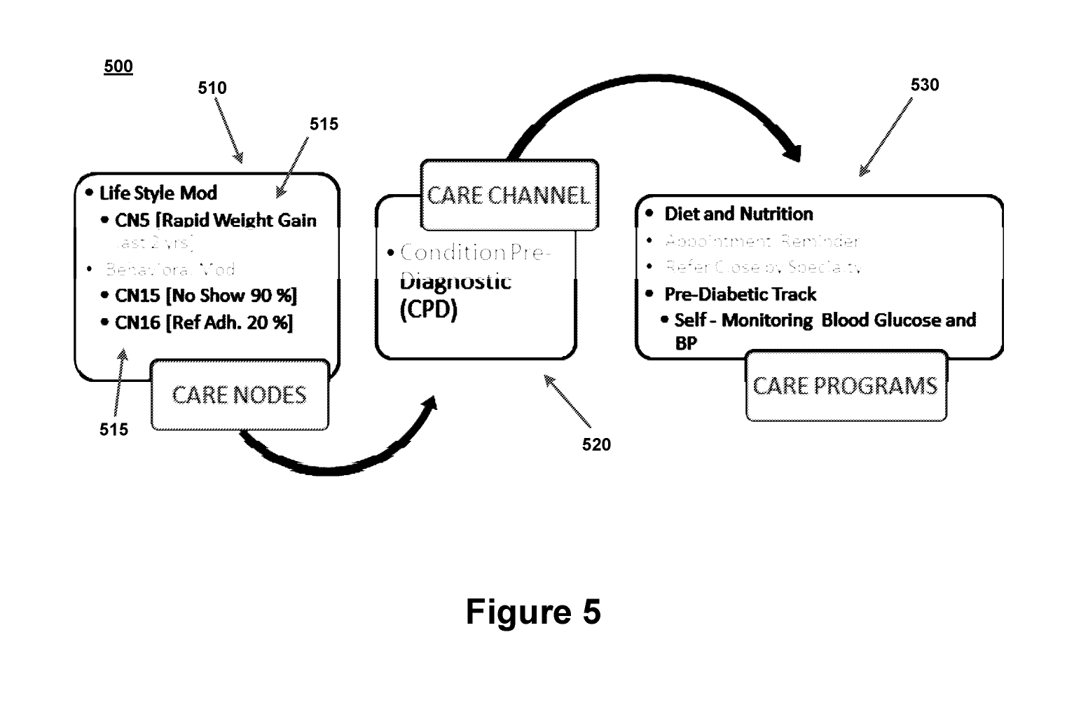

FIG. 5 is a flow chart 500 showing an exemplary process flow for assigning care programs 158 in accordance with certain embodiments. Block 510 shows a plurality of care node flags 515 that have been detected by the medical platform 150. The care node flags 515 indicate the patient has experienced rapid weight gain in the past two years, the patient fails to show up for 90% of medical appointments, and only adheres to 20% of referrals. Block 520 shows that the patient is assigned to the condition pre-diagnostic care channel 156 because the patient has not developed a serious health condition, but has a very high risk of developing a serious health condition (e.g., because of the rapid weight gain). Block 530 shows exemplary care programs 158 assigned to the patient. The care programs 158 selects for the patient are customized based on the detected care node flags 515. For example, because rapid weight gain was detected, the care programs 158 include dietary and nutritional programs, pre-diabetic programs, and programs for self-monitoring blood glucose and blood pressure. Likewise, because the patient fails to regularly attend appointments and referrals, the care programs 158 suggest sending the patient reminders and referring practitioners located near the patient.

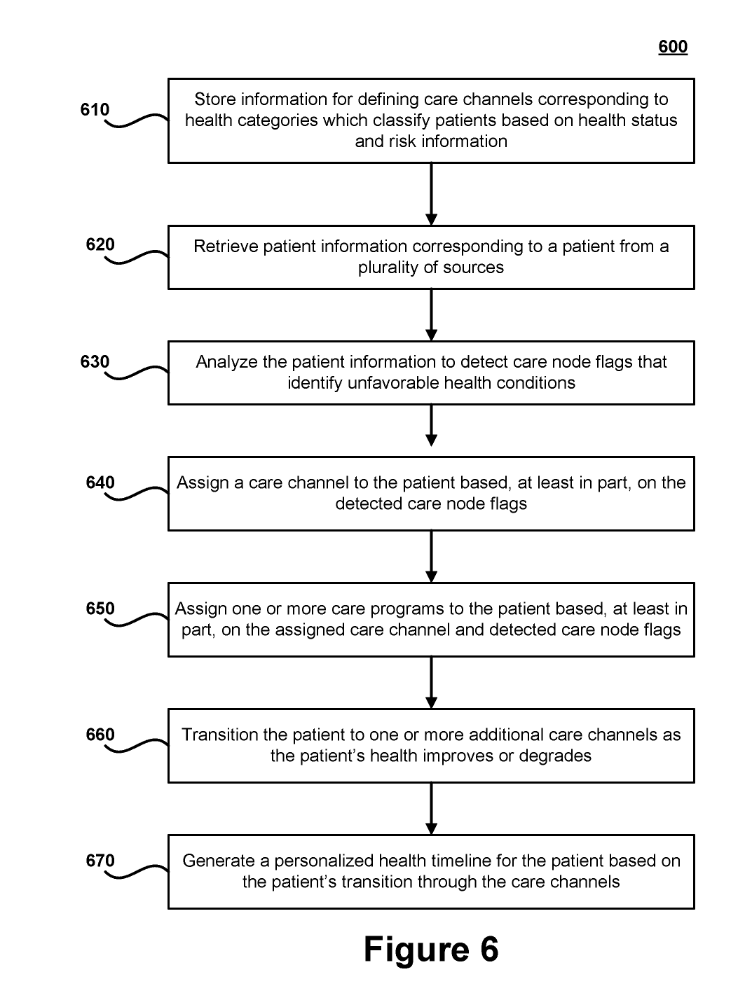

FIG. 6 is a flow chart illustrating an exemplary method 600 for operating a medical platform in accordance with certain embodiments.

In step 610, information is stored for defining care channels 156 corresponding to health categories which classify patients based on health status and risk information. The care channels 156 can be arranged in various ways to classify the patients. In certain embodiments, the care channels 156 represent a spectrum of different health conditions including care channels which represent healthy patients, at risk patients, and unhealthy patients.

In step 620, patient information 152 is retrieved corresponding to a patient from a plurality of data sources 122. The data sources 122 may include any data source which includes information pertaining to patients and/or medical information. The data sources 122 may be stored on the platform hosting device 130 and/or data source devices 120.

In step 630, the patient information 152 is analyzed to detect care node flags 515 that identify unfavorable health conditions. For example, as explained above, the medical platform 150 may analyze patient information 152 that has been imported into care nodes 154 (and associated sub-nodes) to detect unfavorable health conditions. The medical platform 150 includes a rule set for detecting the unfavorable health conditions.

In step 640, a care channel 156 is assigned to the patient based, at least in part, on the detected care node flags 515. The care channel 156 assigned to the patient is based on the health status of the patient. The medical platform 150 includes a rule set and associated logic for defining various care channels 156 and for determining whether patients should be assigned to the care channels 156.

In step 650, one or more care programs 158 are assigned to the patient based, at least in part, on the assigned care channel 156 and detected care node flags 515. The care programs 158 assigned to the patient are customized to address the health conditions and/or other issues (e.g., behavioral patterns of the user) identified by the care node flags 515.

In step 660, the patient is transitioned to one or more additional care channels 156 as the patient's health improves or degrades. The recommended care programs 158 are designed to improve the health of the patient. Thus, if the care programs 158 are successful and the patient's health improves, the patient will be transitioned to care channels 156 associated with better health conditions. On the other hand, if the patient's health degrades, the patient will be transitioned to care channels 156 associated with lesser health conditions.

In step 670, a personalized health timeline 160 is generated for the patient based, at least in part, on the patient's transition through the care channels 156. The personalized health timeline 160 can be provided to the patient in various ways (e.g., in electronic form and/or printed form). In certain embodiments, the personalized health timeline 160 is presented on a graphical user interface and allows a user (e.g., the patient or medical practitioner) to interact with the timeline 160 to view information pertaining to the patient's medical history.

The embodiments described in this disclosure can be combined in various ways. Any aspect or feature that is described for one embodiment can be incorporated into any other embodiment mentioned in this disclosure. Moreover, any of the embodiments described herein may be hardware-based, software-based and, preferably, comprise a mixture of both hardware and software elements. Thus, while the description herein may describe certain embodiments, features or components as being implemented in software or hardware, it should be recognized that any embodiment, feature or component that is described in the present application may be implemented in hardware and/or software. In certain embodiments, particular aspects are implemented in software which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer-readable medium may include any apparatus that stores, communicates, propagates or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

While there have been shown and described and pointed out various novel features of the invention as applied to particular embodiments thereof, it should be understood that various omissions, substitutions and changes in the form and details of the systems and methods described may be made by those skilled in the art without departing from the spirit of the invention. Amongst other things, the steps in the methods may be carried out in different orders in cases where such may be appropriate. Those skilled in the art will recognize that the particular hardware and devices that are part of the system described herein, and the general functionality provided by and incorporated therein, may vary in different embodiments of the invention. Accordingly, the particular system components are provided for illustrative purposes and to facilitate a full and complete understanding and appreciation of the various aspects and functionality of particular embodiments of the invention as realized in the system and method embodiments thereof. Those skilled in the art will appreciate that the invention can be practiced in ways other than the described embodiments, which are presented for purposes of illustration and not limitation.

What is claimed is:

1. A system for monitoring and managing health conditions comprising:
(a) a database that stores information for defining care channels corresponding to health categories which classify patients based on health status and risk information, wherein the care channels are utilized to generate a personalized health timeline for each of the patients by tracking their progression through the care channels; and
(b) a computing device having a processor and a physical storage device that stores instructions, wherein execution of the instructions causes the computing device to:
retrieve patient information corresponding to one of the patients from a plurality of data sources;
analyze the patient information to detect care node flags that identify unfavorable health conditions;
assign a care channel to the patient based, at least in part, on the detected care node flags;
assign one or more care programs to the patient based, at least in part, on the assigned care channel and detected care node flags;
transition the patient to one or more additional care channels as the patient's health improves or degrades; and
generate a personalized health timeline for the patient based, at least in part, on the patient's progression through the care channels.

2. The system of claim 1, wherein the personalized health timeline is analyzed to identify driving conditions that have caused, or contributed to, medical complications or comorbidities for the patient.

3. The system of claim 1, wherein the retrieved patient information is normalized and classified into a plurality of care nodes, each of the care nodes corresponding to a portion of the patient information that is utilized to determine a health status of the patient.

4. The system of claim 3, wherein each of the care nodes is associated with a set of care node flags for identifying unfavorable health conditions associated with the portion of the patient information associated with the care node.

5. The system of claim 1, wherein machine learning techniques are utilized to optimize selections pertaining to the one or more care programs assigned to the patient based, at least in part, on evaluating effectiveness of care programs previously assigned to the patients.

6. The system of claim 1, wherein the patient information at least includes: vital information; laboratory results information; pharmacy information; demographic information; predictive risk score information; disease and chronic condition information;
behavior pattern information; and compliance information.

7. The system of claim 1, wherein generating a personalized health timeline for the patient comprises displaying the patient's medical history in a chronological timeline on a graphical user interface.

8. The system of claim 7, wherein events displayed on the personalized health timeline can be selected to view additional information pertaining to the events.

9. The system of claim 1, wherein execution of the instructions causes the computing device to:
identify a driving condition by executing an automated function which is configured to detect a health condition in the personalized health timeline which occurred first in time and which caused subsequently occurring health conditions.

10. The system of claim 1, wherein the computing device hosts a medical platform that generates the personalized health timeline and the platform can be accessed by both medical practitioners and the patients.

11. A method for monitoring and managing health conditions comprising:
storing, on a non-transitory computer storage medium, information for defining care channels corresponding to health categories which classify patients based on health status and risk information, wherein the care channels are utilized to generate a personalized health timeline for each of the patients by tracking their progression through the care channels;
retrieving patient information corresponding to one of the patients from a plurality of data sources;
analyzing the patient information to detect care node flags that identify unfavorable health conditions;
assigning a care channel to the patient based, at least in part, on the detected care node flags;
assigning one or more care programs to the patient based, at least in part, on the assigned care channel and detected care node flags;
transitioning the patient to one or more additional care channels as the patient's health improves or degrades; and
generating a personalized health timeline for the patient based, at least in part, on the patient's progression through the care channels.

12. The method of claim 11, wherein the personalized health timeline is analyzed to identify driving conditions that have caused, or contributed to, medical complications or comorbidities for the patient.

13. The method of claim 11, wherein the retrieved patient information is normalized and classified into a plurality of care nodes, each of the care nodes corresponding to a portion of the patient information that is utilized to determine a health status of the patient.

14. The method of claim 13, wherein each of the care nodes is associated with a set of care node flags for identifying unfavorable health conditions associated with the portion of the patient information associated with the care node.

15. The method of claim 11, wherein machine learning techniques are utilized to optimize selections pertaining to the one or more care programs assigned to the patient based, at least in part, on evaluating effectiveness of care programs previously assigned to the patients.

16. The method of claim 11, wherein the patient information at least includes: vital information; laboratory results information; pharmacy information; demographic information; predictive risk score information; disease and chronic condition information;
behavior pattern information; and compliance information.

17. The method of claim 11, wherein generating a personalized health timeline for the patient comprises displaying the patient's medical history in a chronological timeline on a graphical user interface.

18. The method of claim 17, wherein events displayed on the personalized health timeline can be selected to view additional information pertaining to the events.

19. The method of claim 11, wherein a driving condition is identified by executing an automated function which is configured to detect a health condition in the personalized health timeline which occurred first in time and which caused subsequently occurring health conditions.

20. The method of claim 11, wherein the computing device hosts a medical platform that generates the personalized health timeline and the platform can be accessed by both medical practitioners and the patients.
